(19) United States
(12) Patent Application Publication
(10) Pub. No.: US 2007/0296963 A1
(43) Pub. Date: Dec. 27, 2007

(54) Methods and Apparatus for Inspecting the Sealing and Integrity of Blister Packages

(75) Inventors: Andrew Ernest Parker, County Down (GB); Neil Stewart, Kent (GB); Matthew E.M. Storkey, Cambridge (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: SEPHA LIMITED, NEWTOWNARDS, COUNTY DOWN (GB)

(21) Appl. No.: 11/597,192

(22) PCT Filed: Apr. 15, 2005
(86) PCT No.: PCT/GB05/01435

§ 371 Date: Aug. 27, 2007

(30) Foreign Application Priority Data
May 20, 2004 (GB) 0411657.0
May 22, 2004 (GB) 0411465.8
Sep. 15, 2004 (GB) 0420796.5

(51) Int. Cl. G01N 21/95

(52) U.S. Cl. 356/240.1

(57) ABSTRACT

A method for detecting an imperfection in a blister package having at least one radiation-transmissible layer, optionally moving, the blister package having a flat side and a pocket side, the method comprising the steps of directing radiation at the flat side and/or the pocket side of the blister package and detecting any radiation emitted from at least one edge of the blister package.

The present invention relates to methods and apparatus for inspecting the sealing and integrity of blister packages, in particular for use in detecting imperfections such as holes, leaks weak seals and broken seals in pharmaceutical blister packaging.

Pharmaceutical blister packages have several different construction mechanisms. These fall into three main categories, namely thermoform, coldform and occasionally tropicalised packages. The commonest forms are thermoform and coldform, which have two sides; a flat top side and a side with a series of pockets, generally termed the pocket side. More particularly, the pocket side comprises a base layer or tray, usually formed from transparent or translucent sheet plastic material, with an additional aluminium foil layer for a coldform package, the tray having a plurality of recessed pockets formed therein for receiving discrete items to be packaged, such as tablets or capsules of a specific drug, and the flat side comprises an upper layer or lidding foil, usually flat, and usually formed from aluminium foil, bonded to the tray to seal each pocket (by creating “a lid” thereover) and provide an airtight seal around the items being packaged.

In a thermoform pack, the items in the pockets are usually visible: in a coldform pack, usually not due to the extra aluminium layer.

If the sealing process is not optimised or if a hole or discontinuity is present in either the tray or lidding foil, a leak has formed or can form, which can allow ingress of moisture, oxygen or air containing bacteria. Research has shown that the ingress of moisture, oxygen or air containing bacteria into packaging can significantly reduce the shelf life of a pharmaceutical drug. It is therefore necessary to test the integrity of each pocket of the blister package. It is also necessary to identify for other imperfections such as weakly sealed areas which may not possess a leak but which develop or may have a high probability of developing a leak. In the field of pharmaceuticals, it is better to be safe than sorry, i.e. better to reject any potentially unsafe blisters before sale or use.

In one manufacturing process, a blister pack has pockets which are covered by a flat aluminum foil. The aluminum foil around these flat parts is covered by indentations. These indentations are made by a stamp and ensure that the aluminum foil adheres properly to the plastic underneath (to form ‘the seal’). If these indentations are not deep enough, this is a sign that the seal process was not optimal and that there is a possibility of air leaking into a pocket.

A further category of imperfection can occur in the sealing process. A small channel may form between the pocket containing the drug, and the edge of the blister package. This is known as a capillary. It is also desirable to detect capillaries as they can also cause ingress of moisture, oxygen, air and bacteria.

Suggestions have been made in the art such as in U.S. Pat. No. 5,363,968 and U.S. Pat. No. 6,757,420 for inspecting moving blister packages. The former patent requires capturing a picture of the blister with a high speed camera, and comparing it with nominal characteristics from a test blister, which does not therefore involve an absolute method of analysis of each blister package in its own right. The latter US patent requires lights of different colours and analysis of various wave interference patterns, which requires very accurate placing arrangements to ensure that the interference patterns, based on what should be flat surfaces, are correctly detected. No prior art suggestions are known to be operable and commercially available.

Current commercial methods for detecting imperfections are based on batch testing. A sample of packages is taken from the production line and subjected to a testing procedure which determines the integrity of the sealing process. Testing techniques include liquid ingress (e.g. a blue or green dye test), ultrasonic testing, or vacuum testing such as described in our U.S. Pat. No. 6,687,622. Leakage of gas from minute holes in the packages during evacuation can be detected in gas evacuated from the chambers, and can thereby be used to detect presence of the holes. Alternatively, pressurizing or partially evacuating the chambers causes gas flow though the minute holes into or from the packages; subsequent abrupt return of the chambers to initial pressure causes momentary distortion of flexible wall layers of the packages which is indicative of the presence of the minute holes. Such distortion can be determined by, for example, visual inspection or profile interrogation using laser beams. Such apparatus can provide very accurate diagnostic ability, but not with any speed. Indeed, all of these techniques are useful for off-line testing but are not fast enough to offer the prospect of 100% on-line inspection.

The present invention provides improvements over existing techniques because it is able to implement weak seal and leak detection at a sufficiently high or fast rate to be applied to on-line or continuous blister package inspection, offering the opportunity to implement testing of all blister packages, rather than batch testing of only some.

Thus, the present invention is able to test all blister packages at the rate of blister package mass-production, requiring no slowdown or reduction in blister packaging manufacture whilst still providing testing of all packages formed.

The present invention can also provide very accurate imperfection locational information.

It is another object of the present invention to provide a non-destructive test, that is a method and apparatus for inspecting the sealing and integrity of blister packages that does not affect the packages or their contents. This is extremely beneficial in the field of pharmaceuticals, where pharmaceuticals from any failing or rejected blister packages can be extracted for re-packaging, and/or blister packages which pass or succeed the testing are still in a form which is acceptable for sale and use under the various pharmaceutical regulations.

Another object of the present invention is to improve the accuracy of continuous testing, i.e. reduce the size of imperfection that is detectable at speed from only ‘gross’ holes or the like, to ‘small’ or ‘weak’ imperfections.

According to a first aspect of the present invention there is provided a method for detecting an imperfection in a blister package having at least one radiation-transmissible layer, the blister package having a flat side and a pocket side, the method comprising the steps of directing radiation at the flat side and/or the pocket side of the blister package and detecting any radiation emitted from at least one edge of the blister package.

Thus, any imperfection in the flat side and/or pocket side of the blister package will result in ingress of radiation into the blister package, which radiation will at least partly enter the radiation-transmissable layer and be directed therethrough to its edges which are co-incidental with the edges of the blister package. Thus the light that is transmitted through the radiation-transmissable layer is detectable at the edges of the blister package.

Preferably, the blister package is moving, and is being conveyed whilst undergoing the method of the present invention, or is wholly or substantially stationary having being conveyed to a location for undergoing the method of the present invention, and then is conveyed therefrom thereafter. Preferably, the method of the present invention involves detecting an imperfection in a plurality of moving or conveyed blister packages, optionally at high speed.

By directing the radiation at the flat side and/or pocket side of the blister package, locational information as to the exact position of any imperfection can also be obtained. This information can be used to consider where any fault or flaw in the process for manufacturing the blister package is or has occurred. For instance, the re-occurring detection of an imperfection such as a hole in the same position on a number of blister packages could indicate the position of an unwanted sharpness or edge in the forming process. Similarly, a re-occurring weakness in the seal may indicate where forming rollers have become worn and are providing insufficient forming pressure.

Preferably the method comprises the further step of determining the presence of a hole in a pocket or the lid of a pocket of the blister package based upon the detected intensity of radiation emitted from the edges of the blister package. The radiation can be directed through movement, e.g. scanning, possible raster scanning, or spreading a source of radiation, generally a beam, by, for example, using a divergent means, such as a splitter, scatterer or a moving mirror.

Preferably, the radiation is detecting wholly or substantially in alignment with one edge or possibly opposing edges of the blister package.

Preferably the step of directing radiation onto the flat side and/or the pocket side of the blister package is carried out across the whole surface of at least each pocket of the pocket side, and equivalent area of the flat side (being the pocket “lid”), optionally across the whole surface of each or both said sides of the blister package.

According to a second aspect of the present invention there is provided an apparatus for detecting an imperfection in a blister package having at least one radiation-transmissible, the blister package having a flat side and a pocket side, the apparatus comprising means for directing radiation at one or both sides of the blister package means for detecting any radiation emitted from at least one edge of the blister package.

Preferably the radiation is a focused beam, and comprises an optical light source, more preferably a laser. Preferably the laser light is deflected through a beam scanner or mirror for raster scanning the beam of light from the light source across the said side of the blister package in a direction transverse to the direction of movement of the blister package through the apparatus.

Preferably the means for detecting the radiation, preferably for measuring the intensity of radiation, emitted from the edges of the blister package comprises one or more photo-detectors, preferably located wholly or substantially in alignment with the edge or edges of the blister package.

Preferably a signal processing unit is provided processing the radiation intensity measurements recorded by the photo-detectors to determine the occurrence of changes in the measured radiation levels indicative of one or more imperfections such as holes or apertures in the package.

Preferably the blister packages are conveyed through the apparatus, and conveying and/or guide means are provided for conveying and/or guiding the blister packages through the apparatus.

The apparatus may include means to reduce and/or exclude the radiation, e.g. light, other than from the radiation source, being present around the blister package under investigation, and/or the radiation being detected by the detector(s). Such means includes one or more light barriers, shrouds, curtains, etc. or the like. Such means may be movable with the blister package, and/or moveable relative thereto, or static.

According to a third aspect of the present invention, there is provided a method for detecting an imperfection in the flat side of a blister package, the blister package having a flat side and one or more radiation-transmissible pockets on a pocket side, the method comprising the steps of directing radiation at the flat side of the blister package and detecting any radiation emitted from the or each pocket.

Thus, where the pocket side is formed from a transparent or translucent material only, any imperfection such as a hole or aperture in the lid area of the flat side above a pocket will allow radiation to enter the pocket therebelow, which radiation is then radiated and emitted through the transparent or translucent layer. Other forms of radiation are usable where they are impassable through the material of the flat side, but are transmissible through the material through the pocket side. This method is particularly suitable for thermoform blister packages.

According to a fourth aspect of the present invention, there is provided apparatus for detecting an imperfection in the flat side of a blister package, the blister package having a flat side and one or more radiation-transmissible pockets in a pocket side, the apparatus comprising means for directing radiation at the flat side of the blister package, and means for detecting any radiation emitted from the or each pocket of the blister package.

The radiation and means for directing the radiation may be as herein described, along with the means for detecting the radiation. The means for detecting the radiation may include means for detecting the intensity of the radiation.

According to a fifth aspect of the present invention, there is provided a method of detecting an imperfection in a blister package having at least one radiation-transmissible layer, the blister package having a flat side and one or more pockets in a pocket side, the method comprising the steps of scanning a beam of radiation at the flat side and/or the pocket side of the blister package and detecting any radiation, preferably the intensity of any radiation, emitted from the pocket(s) and/or at least one edge of the blister package.

Scanning provides a rapid means of providing a high intensity of radiation across a surface, so that any imperfection over a small area such a hole 5 μm wide will be subjected to a high intensity of radiation, and allow a sufficient amount of radiation therein to propagate thereinafter to detection.

Scanning also provides a means of providing very accurate locational information as to the position of the imperfection, the benefit and consequence of which is discussed hereinbefore. Moreover, scanning provides an ability to scan across a whole blister package surface such that there is no shadowing, and also ensures that the blister package is illuminated with an even intensity.

The imperfection may be in the form of a hole or aperture, and the radiation may be in the form of light, preferably a laser.

According to a sixth aspect of the present invention, there is provided apparatus for detecting an imperfection in a blister package having at least one radiation-transmissible layer, the blister package having a flat side and one or more pockets in a pocket side, the apparatus comprising means for scanning a beam of radiation across one or both sides of the blister package, and means for detecting the presence, preferably the intensity, of any radiation emitted from the pocket(s) and/or at least one edge of the blister package.

Preferably, the type of radiation, means for scanning the radiation, and means for detecting the presence, and optionally also the intensity, of radiation are as herein described.

According to a seventh aspect of the present invention, there is provided a method of detecting an imperfection in the pocket side of a blister package, the blister package having a flat side and pocket side, the method comprising the steps of directing radiation at the pocket side of the blister package and detecting the angle and/or intensity of radiation reflected therefrom.

The radiation is preferably static, and may be provided by one or more sources such as one or more lights. Preferably, the blister pack is illuminated with an even intensity of radiation, and there is no shadowing visible on the blister package surface. More preferably, the blister package is moving whilst undergoing the method of the present invention.

The method of detecting the angle and/or intensity of radiation reflected can be as hereindescribed.

According to an eighth aspect of the present invention, there is provided an apparatus for detecting an imperfection in the pocket side of a blister package, the blister package having a flat side and pocket side, the apparatus comprising means for directing radiation at the pocket side of the blister package, and means for detecting the angle and/or intensity of radiation reflected therefrom.

The form of radiation, means for directing the radiation and means for detecting the angle and/or intensity of radiation reflected therefrom can be as hereindescribed.

According to an ninth aspect of the present invention there is provided a method for inspecting the sealing of a blister package, the blister package having a flat side and a pocket side, at least a portion of one or both sides having a textured surface, the method comprising the steps of directing radiation at the textured surface of the blister package at an angle of incidence of greater than 0° and detecting the angle and/or intensity of radiation reflected therefrom.

The term “textured surface” is intended to mean any surface finish that is not smooth. Preferably the textured surface comprises a regular pattern of raised portions and intervening depressions.

Preferably the steps of directing radiation onto one or both sides of the blister package and detecting the angle and/or intensity of radiation reflected therefrom are carried out across at least a portion of the surfaces of the blister package.

According to a tenth aspect of the present invention there is provided an apparatus for inspecting the sealing of a blister package, the blister package having a flat side and a pocket side, at least a portion of the one or both sides having a textured surface, the apparatus comprising means for directing radiation at the textural surface of the blister package at an angle of incidence of greater than 0° and means for detecting and angle and/or intensity of radiation reflected therefrom.

Preferably the means for detecting the angle and/or intensity of radiation reflected from one or both sides of the blister package is adapted to detect the angle and/or intensity of the reflected radiation across at least a portion of the or each side thereof.

In a preferred embodiment the radiation comprises visible light. This permits the use of inexpensive and readily available sources of light, such as LEDs or the like. Such radiation could be a single source or any array, optionally an ordered array, adapted to provide regular light across the textured surface. Alternatively, the radiation comprises a beam of coherent light from a laser. Preferably, the light source is chosen so that there is no shadowing visible on the blister pack surface and so that the entire blister pack is illuminated with an even intensity.

Preferably the angle of incidence of the radiation directed at the textured surface is less than 45°, more preferably between 10° and 30° to the plane of the blister package.

In a preferred embodiment the detecting means is arranged to detect the intensity of radiation reflected in a direction substantially normal to the flat side(s) of the blister package.

Image processing means may be provided for determining the pattern of reflected radiation across at least a portion the surface(s) side of the blister package. Said image processing means may compare said pattern of reflected radiation with a standard or quality control reference, e.g. that expected of a well-sealed package, or with other calibration data to determine the presence of overall and/or localised regions of weak or faulty sealing. The image processing means may comprise a camera connected to a computing device.

The angle and/or intensity of radiation reflected off the textured surface may also provide a measure of the depth of the textured surface, and thus a mesure of the strength of the seal created between the materials used for the flat side and pocket side of the blister package. One manner of analysing the angle and/or intensity of radiation detected is to determine the quality of radiation received at a number of different threshold levels, and/or in a number of predetermined areas. Computation of such information can provide a ‘map’ of the inspected surface, and an indication of those areas of the surface which pass or fail any predetermined or threshold values set. Such information can determine edge-to-pocket sealing as well as pocket-to-pocket sealing information. Some areas of the surface may be insufficient, but if such areas do not extend to the edge of a pocket and/or the edge of the blister package, it may in fact allow the blister package still to be considered to pass the determination of a good seal.

Preferably conveying and/or guide means are provided for conveying and/or guiding the blister packages through the apparatus hereindescribed.

Preferably the methods of the present invention include the further step of determining the acceptability of the blister package based on what is detected, for instance the sealing of the blister package based upon the detected angle and/or intensity of the reflected radiation. Such acceptability determination may be in the manner of a decision as to whether the package being inspected meets or fails to meet a particular quality requirement or may determine the quality of the pocket, foil, seal, etc as falling into one of a range of levels of quality, some being rejected, some accepted and other being identified as requiring further checking, e.g. by a static ‘batch’ testing apparatus.

Preferably the apparatus of the present invention further comprises means for determining the acceptability of the blister package based on what is detected, e.g. the sealing of the blister package based upon the detected angle and/or intensity of the reflected radiation.

Blister packages which are able to be inspected by the present invention may be of any suitable size, shape or design, and may be able to contain any suitable items which it is desired to protect in one way or another between their point of manufacture and point of sale. Such includes pharmaceuticals, commonly but not exclusively in a solid form such as tablets or capsules, as well as optical items such as contact lenses and electronic items such as microchips or the like, and small electrical circuit items or pieces. The person skilled in the art will be aware of other items suitable for blister packaging.

Such packaging may be for health and safety concerns, and/or may be to assist compartmentalisation of suitable items either to assist in manufacture, sale or use. It will also be noted that a blister pocket may contain more than one item, or that different pockets may contain different items. Generally, but not exclusively, all pockets of a blister package contain the same item. Also commonly, but not exclusively, all blister packages formed in a ‘batch’ contain the same or related items. A ‘batch’ is generally any group of blister packages made under the same conditions and with the same materials and for the same enclosed item.

The methods and apparatus of the present invention include the ability to be adapted to accommodate blister packages of different size, shape and design. This may require some adjustment of physical and/or radiation parameters, but such is within the skill of the person skilled in the art. The present invention is not limited by the size, shape and dimensions of the blister packet, or the items within the blister pocket.

The term “continuous” and/or “on-line” as used herein relates to the ability of the present invention to inspect moving blister packages, and blister packages at the rate at which they are formed, filled and sealed. This is in contrast with ‘batch testing’ which is static testing of a sample of blister packaged formed. Batch testing of all blister packages could of course be carried out, but the loading and unloading of blister packages from batch testing apparatus make this un-economical. The continuous or on-line inspecting of blister packages by the present invention may still involve one or more times when a blister packet is stationary, or may be intermittent due to the intermittent manufacture of blister packages, but it is still intended that all blister packages formed, filled and sealed undergo the inspection of the present invention prior to distribution, sale, use, etc.

The present invention is also able to be carried out at atmospheric conditions, that is it does not require any increase or decrease in pressure on or around the blister packages. This significantly reduces the complexity of the invention compared with many prior art devices, which require some form of increase or decrease in pressure, in particular applied vacuum. The present invention can therefore be easily applied in connection with general blister package manufacturing processes.

The present invention preferably includes a method and apparatus to indicate and/or cause the acceptance or rejection of a blister package either during or after its inspection. This could include one or more decision stations and/or one or more gates, adapted to act upon the information provided by the method of inspection. The present invention could also therefore include one or more locations or areas considered to receive or accept blister packages which pass or succeed the method of inspection, and one or more areas adapted to accept or receive blister packages which are considered to fail or be rejected by the method of inspection.

The present invention could also be adapted to make a decision on the acceptance or passing of a blister pack by the method of inspection, or its rejection or failure, either manually and/or automatically. Such ability may include action concerning one or more blister packages following any rejected or failed blister package, e.g. the next five blister packages just in case there could be a continuing fault in the manufacturing process, as well as ability to stop the inspection, for example to allow manual inspection or further and/or re-testing of the blister package.

In the present invention, blister packages may be inspected in a step wise or indexed manner. Preferably, they are inspected in a continuous manner, and are supplied in a continuous form. Blister packages may be supplied by any suitable feeding mechanism known in the art, preferably one at a time.

The present invention may include one or more channels through which a blister package may pass for inspection. Such channels may equate to one or more apparatus for each test acting in series or parallels. One or more of each apparatus may be adapted to work with the same or different number of other apparatus. In one embodiment, apparatus for detecting imperfections such as holes in a blister package can operate at a rate sufficient to supply a number, such as 2-4, apparatus for detecting imperfections such as weak seals and capillaries.

According to further aspects of the present invention there is provided a leak detection system for detecting one or more leakage holes in a package, the system comprising translating means for translating the package through the system; radiation interrogating means for generating a spatially scanned beam of interrogating radiation for scanning over at least part of the package; and radiation detecting means for detecting interrogating radiation transmitted through said one or more leakage holes into the package and thereby determining whether or not said one or more holes are present in the package; and a method of using a system for detecting one or more leakage holes is a package, the method comprising the steps of translating the package through the system, generating a spatially scanned beam of interrogating radiation and scanning the beam over at least part of the package; and detecting interrogating radiation transmitted through said one or more leakage holes into the package and thereby determining whether or not said one or more holes are present in the package.

The present invention also provides a continuous method of inspecting blister packages wherein radiation, preferably visible radiation, is directed onto one or both sides of the package, preferably to detect an imperfection of 5 μm or equivalent.

The term “imperfection” as used herein relates to any deficiency in the formation and/or sealing of a blister package. This includes holes, leaks, weak and broken seals, and capillaries, in whatever form.

The term “imperfection of 5 μm or equivalent” as used herein relates to a hole of five micron wide, or a space such as a capillary which is able to allow to the same volume or amount of a gas, e.g. air, therethrough. Such can be measured by comparison testing e.g. in a static vacuum test, to equate the ‘size’ of a capillary or weak seal with a defined ‘equivalent’ hole size.

The methods and apparatus of the present invention can be used to detect imperfections across the whole of a blister package, preferably without shadowing of any part of the package. The methods and apparatus also preferably use an even intensity of radiation and in particular for detecting holes, a focused beam of radiation, such as a laser beam. They may also be designed to particularly cover areas of more importance, such as the pockets and areas of the flat side above the pockets (“lids”), as well as areas therearound, and possibly edges. There may be some parts of a blister packet which have a weak seal, but which are sufficiently separated from a pocket and/or edge of the blister package so as not to be critical to the overall sealing of the blister pockets themselves.

The invention further provides a blister package testing method and/or apparatus comprising, in combination, a method and/or apparatus according to any one aspect of the present invention with a method and/or apparatus according to any one or more other aspects of the present invention, optionally including any one of the embodiments described therewith.

It is inherent that any method or apparatus of the present invention for detecting an imperfection is a method or apparatus capable of or for use in such detection, which method or apparatus operates on and inspects good and bad blister packages alike, and whose intention is to detect an imperfection as and when such is present.

Embodiments of the invention will now be described, by way of example only, with reference to the diagrammatic drawings, in which:

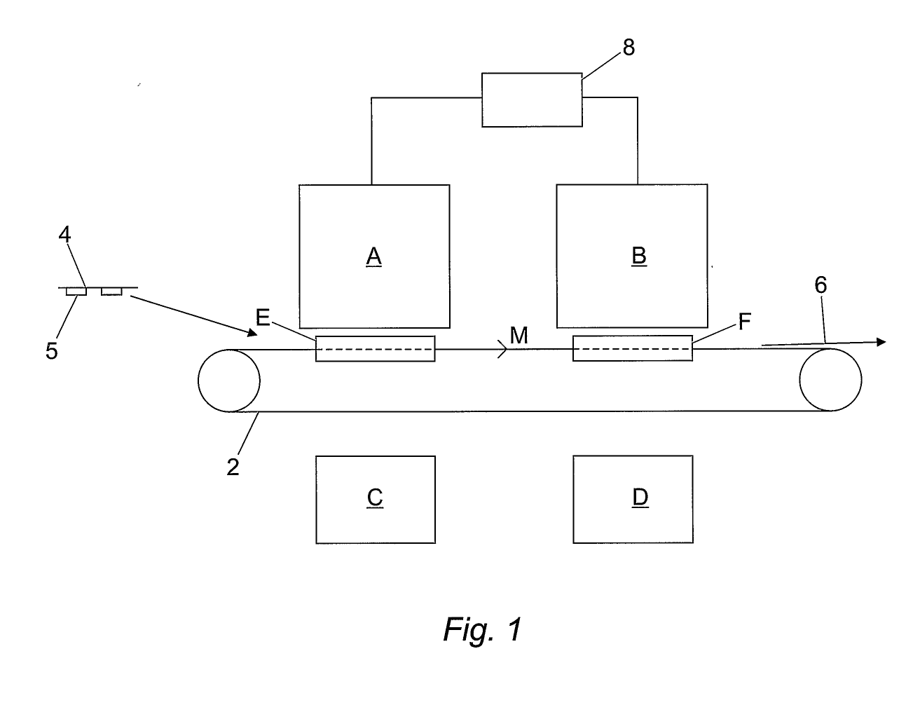

FIG. 1 is a schematic simplistic side view of an imperfection detecting apparatus according to an embodiment of the present invention;

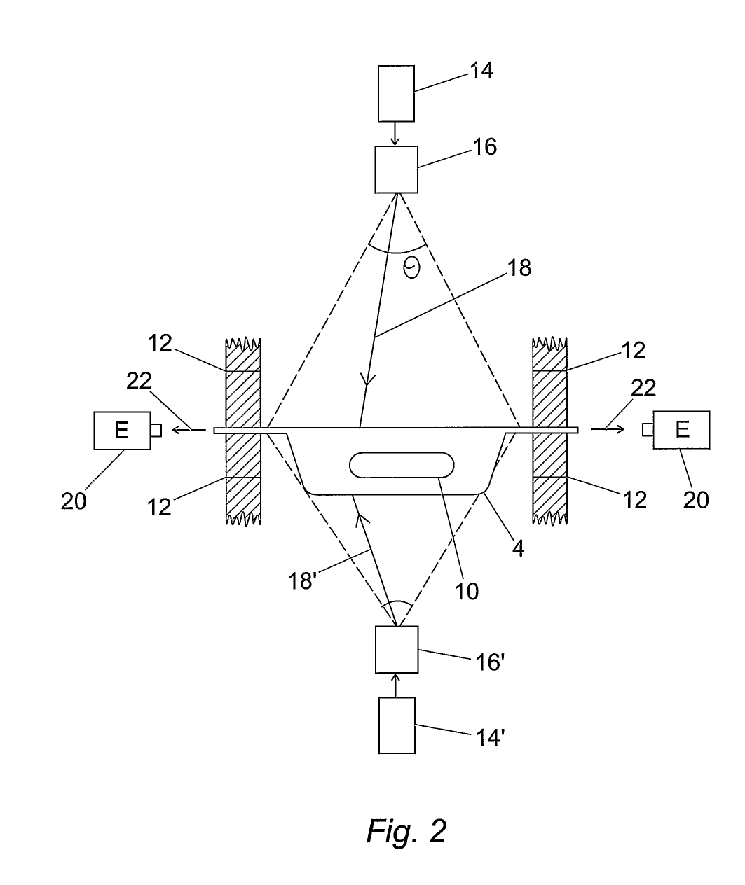

FIG. 2. is a front view of a blister package passing through the apparatus of FIG. 1;

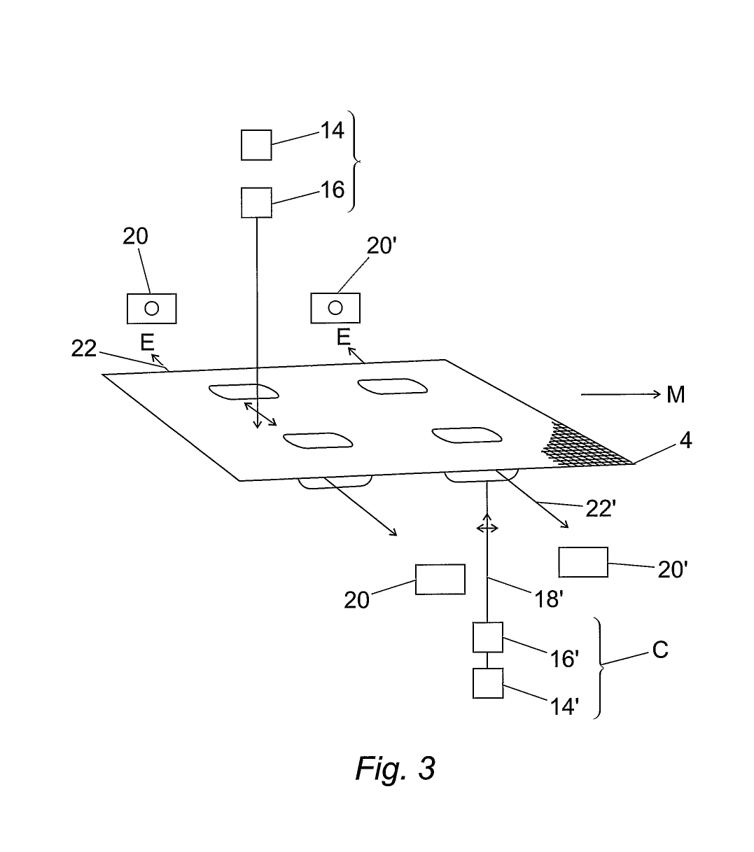

FIG. 3 is a simplified perspective view of FIG. 2;

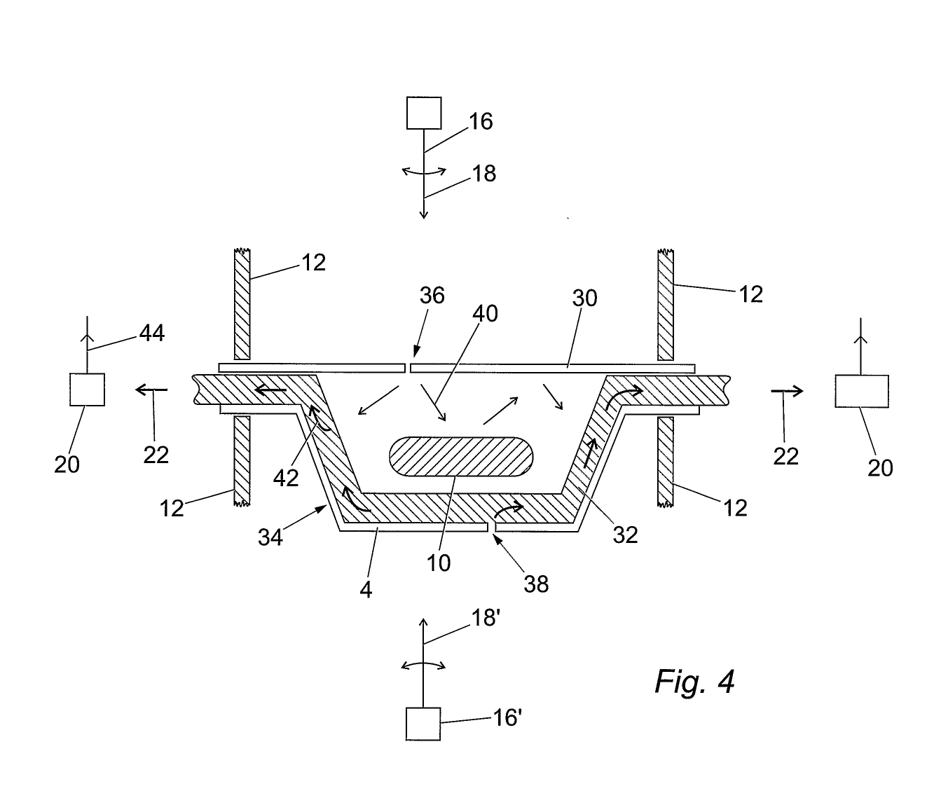

FIG. 4. is a detailed cross-sectional view of FIG. 2;

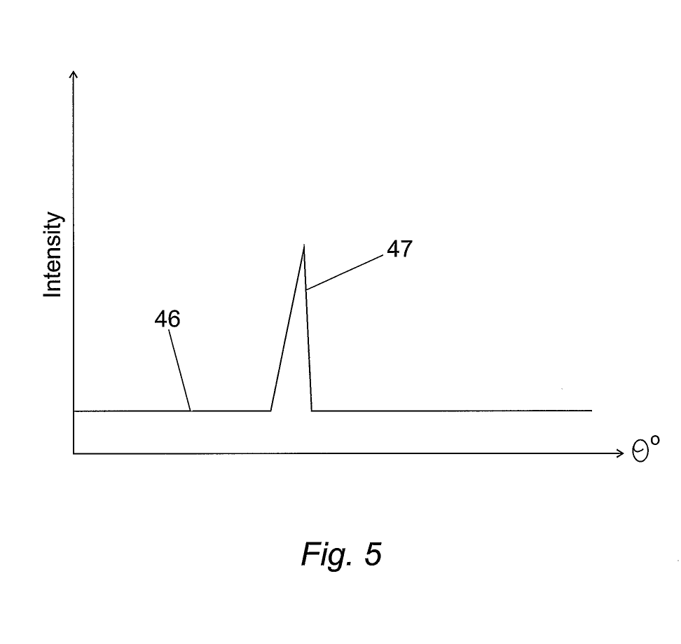

FIG. 5. is a graph illustrating photo-detector output of the apparatus of FIG. 1;

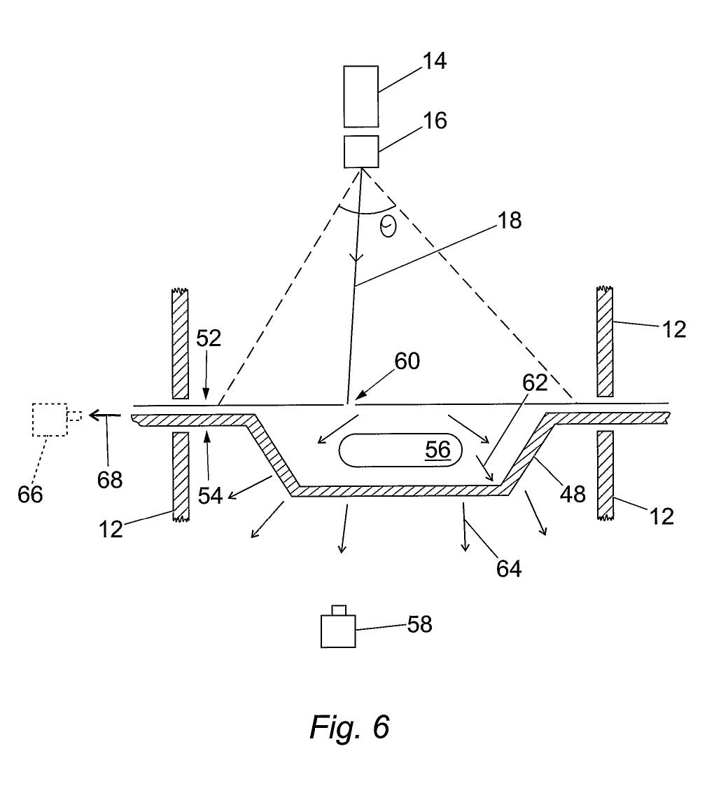

FIG. 6. is a side cross-sectional view of another blister package passing through the apparatus of FIG. 1;

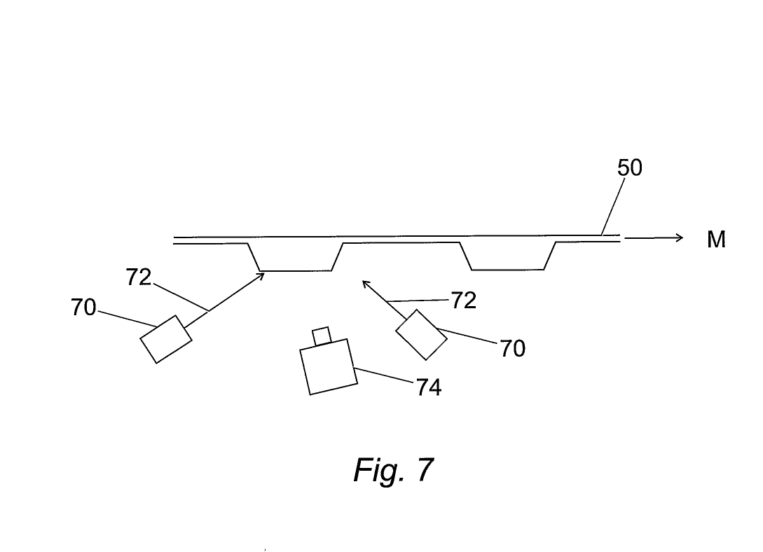

FIG. 7. is a simplified view of another embodiment of the present invention;

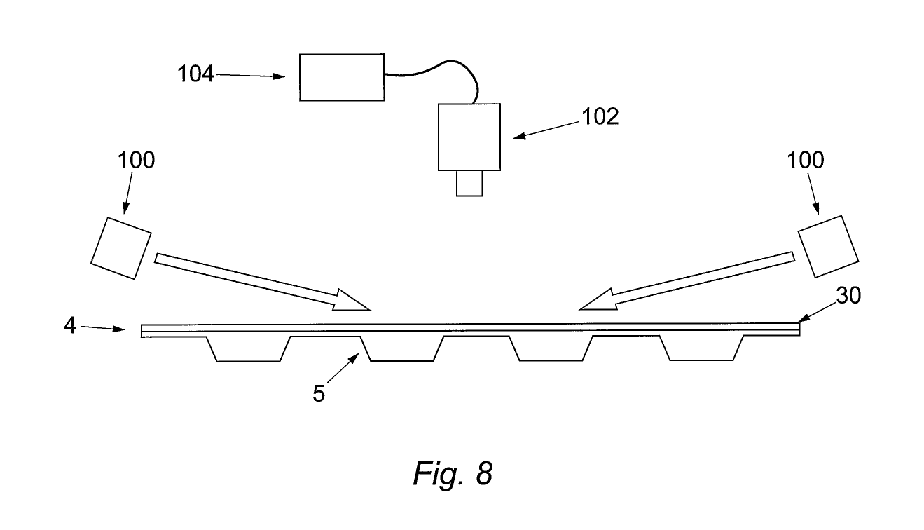

FIG. 8 is an inspecting system according to another embodiment of the present invention;

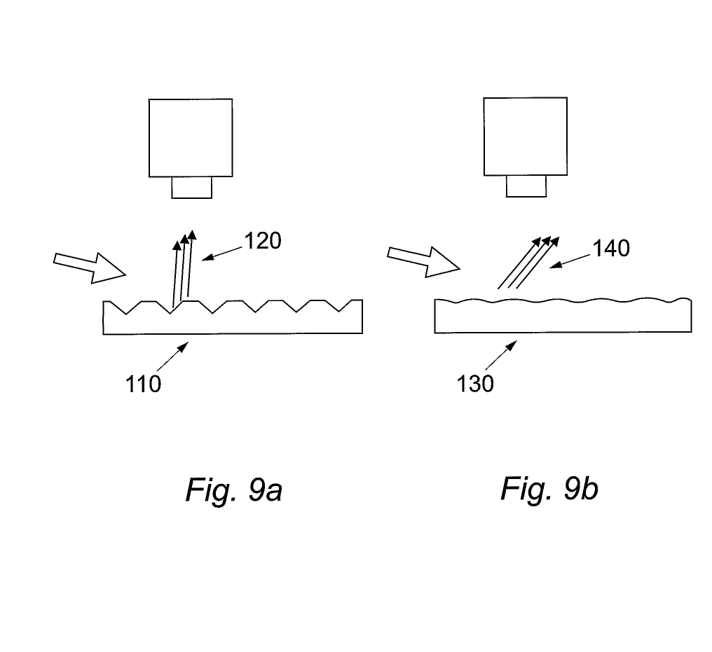

FIG. 9a shows the reflection of incident light from the textured surface of the flat side of a blister package having a strong or good seal;

FIG. 9b shows the reflection of incident light from the textured surface of the flat side of a blister package having a weak or failed seal;

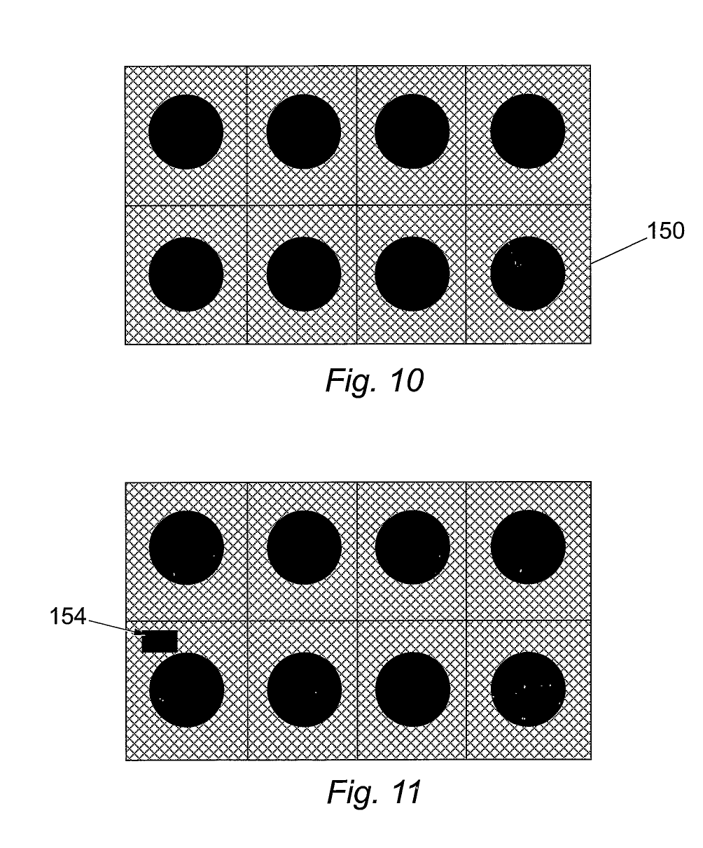

FIG. 10 shows the variation of intensity of reflected light across the flat side of a blister package having a strong seal;

FIG. 11 shows the variation of intensity of reflected light across the flat surface of a blister package having a weak seal in a localised region;

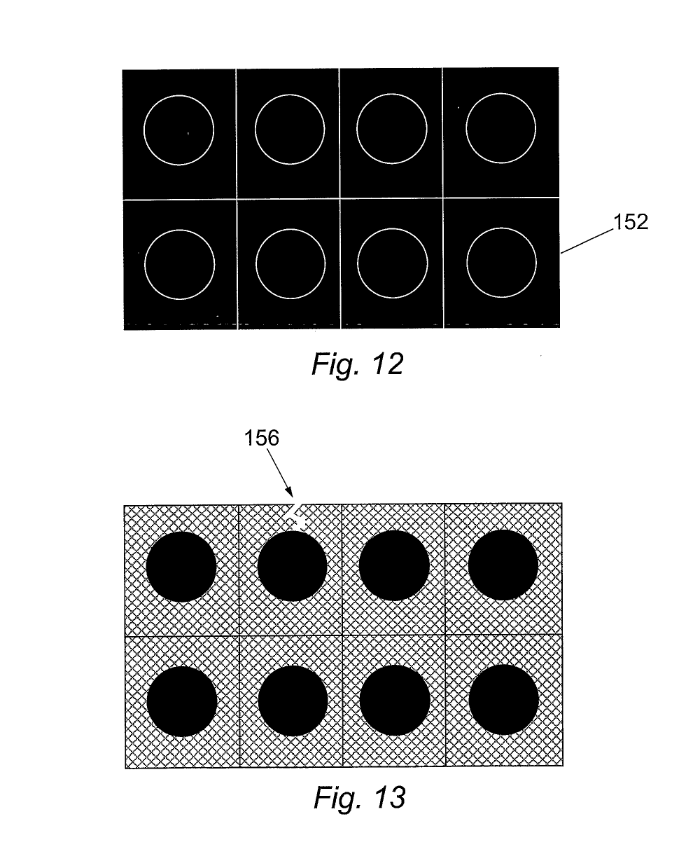

FIG. 12 shows the variation of intensity of reflected light across the flat side of a blister package having a weak seal; and

FIG. 13 shows the variation of intensity of reflected light across the flat surface of a blister package having a capillary.

A typical coldform blister package 4 comprises a tray 5 or lower layer, usually formed from aluminium foil 34 and a plastic 32 having a thickness in a range of 10 μm to 45 μm, having pockets for accommodating pharmaceutical products such as orally ingestible medicines, medical implements such as needles and stents, and other types of products that need to be protected from exposure to ambient atmosphere during storage prior to use. The blister package 4 further comprises a lidding foil 30 affixed to the surface of the tray 5 to seal the tablets within the pockets. The lidding foil 30 can a thickness in a range of 10 μm to 150 μm.

In order to improve the seal of the lidding foil 30 onto the plastic layer 32, the blister package 4 is usually passed through the nip of heated embossing rollers, or is pressed between a pair of embossing plates, whereby a cross-net, cross-hatch, indented or dot type pattern is embossed onto the tray 5 and attached lidding foil 30. This produces a textured surface finish on at least the flat side of the finished blister package. In particular, it is expected, and generally achieved, that the surface is textured in a regular and/or organised pattern. The outer surface of the tray 5 may also have a textured surface across part or all of it under certain manufacturing conditions.

However imperfections such as holes or “weak seals” i.e. an area of the blister package where the base layer and upper layer have not bonded together, or have bonded in an insufficient manner which can or could possibly allow the passage of water, moisture, etc therethough, can occur, possibly due to a roller imperfection, or lack of pressure of the rollers, wear of parts, or lack of required temperature.

FIG. 1 shows a simplified side view of apparatus according to one embodiment of the present invention. Generally, the apparatus includes a conveyer apparatus 2, which could be a conveyer belt and operating rollers at each end. On the conveying belt can be located blister packages, a representative blister package 4 being shown having a tray 5.

The blister packages 4 travel along direction M, and have an exit place 6. Along the route of the conveying apparatus 2, there are located one or more inspecting stations. Each inspection station generally includes at least one source of radiation, and at least one means of detecting radiation. In FIG. 1, there is exemplified two stations. Each station could have a source of radiation and means for detecting the radiation above (A and B) and/or below (C and D) the conveying apparatus and/or wholly or substantially along side and in alignment with the passage of the blister packages (E and F).

The present invention extends to the use of any number of stations in the apparatus, such stations either being in series, in parallel, or a combination of both. The or each station may include one or a combination of locations of a source of radiation, and/or means for detecting the radiation.

FIG. 1 also shows in a symbolic manner a signal processing means and display means 8. Such means would be connected to the or each part of the apparatus in order to function as described hereinafter, and may provide suitable visual and/or oral information to the user. Such means 8 may also include means for operating the apparatus.

Conveying apparatus 2 is well known in the art, and can include the use of a conveyer belt and/or series of rollers able to convey a blister package from a place of entry to the apparatus, such as the feeding tray or magazine, and a place of exit 6 from the apparatus and/or place of acceptance or rejection of the blister package after having been inspected. Such conveying apparatus 2 may include one or more guide means, again including rollers and the like, which are well known in the art.

The apparatus of the present invention may be connected directly or indirectly to a blister package production line, such that once the blister package 4 is formed, filled and sealed, it is passed wholly or substantially directly through the apparatus of the present invention. The movement of the blister packages provides the “continuous” or “on-line” ability of the present invention over hitherto ‘static’ batch testing.

FIG. 2 shows a blister package across the line of direction M. The radiation source 14 emits a beam of radiation which propagates from an output port of the source 14 to an input port of the scanner 16. The scanner 16 deflects the beam 18 to provide a temporally-scanned output beam 18 which is scanned along an axis substantially transverse to that in which the packages 4 are moved through the apparatus. The beam impinges on a flat side of the packages 4 and is reflected as upwardly-scattered radiation.

The radiation source 14 is preferably a solid-state laser diode outputting, in operation, a 50 mW beam of radiation of substantially red colour.

Alternatively, other bright optical sources can be employed, for example a helium-neon laser. Moreover, the scanner 16 is preferably capable of scanning at a line scanning rate in a range of 1 kHz to 10 MHz. To achieve such scanning rate, the scanner 16 is preferably a multifaceted optical component with associated drive device for rotating the component at a relatively high rotation rate; for example, the component preferably comprises 30 facets and is rotated at a rate in a range of 50 to 500 turns per second. Alternatively, opto-acoustic modulators and/or holographic optical elements can be employed for laser beam scanning purposes.

In response to receiving any internally reflected radiation 22 as described hereinafter, the detector 20 generates a signal 44 which propagates to the processing unit 8 wherein the signal 44 is analysed with respect to instantaneous scanning angle θ of the beam 18. If there is no imperfection, especially a hole in the blister package 4, no light will be detected by the detectors 20.

The blister package 4 passes through upper and lower guide rollers 12 which are adapted to inhibit the passage of light from the beam 18 other than as described hereinafter. Other means such as curtains, or moving walls could be used as light barriers or inhibitors between the pocket area and the package edges. Light at only one edge of the blister package could be detected if desired.

FIG. 3 is a perspective view of part of FIG. 2, showing the offset nature of an upper radiation source 14 and scanner 16 which could be located in position A of FIG. 1, and a lower radiation force 14′ and scanner 16′, which could be located in position C of FIG. 1. Scanner 16′ provides a scanned beam 18′, whose tranverse relected radiation 22′ can be detected by detectors 20′ which could be located in position E of FIG. 1.

Turning to FIG. 4, when a hole (two are simultaneously shown in FIG. 4 for co-illustrative purposes) 36, 38 is present in the package 4, and the beam 18 is directed towards the hole 36, 38, the beam or a fraction of the beam is transmitted through the hole 36, 38 and subsequently at least partially reflected and scattered by the product 10. Radiation reflected from the product 10 is reflected from an inside reflective surface of the tray 5 and at least some of the radiation propagates as multiply-reflected beams 40 to the light-transmissible plastics material layer 32 which functions as a light waveguide to guide the light in the form of beams 42 towards peripheral edge regions of the package 4.

Thus, the scattering within the package 4 and optical guiding provided by plastic films used in manufacture of the package 4 (i.e. the light transmissive plastics material film 32) conveys light transmitted through the one or more holes 36, 38 to be re-emitted from lateral edges of the package 4 to yield one or more peaks in the signal 44. The presence of these one or more peaks as a function of beam 18 scanning angle θ is indicative of whether or not one or more holes are present in the package 4 which could result in a shorter shelf life for their pharmaceutical contents.

It will be appreciated that small holes present in a package layer 4 can be detected in a similar manner by passing the package 4 upside-down through the apparatus. It will be appreciated that two such apparatus can be configured in series, one in an upside down configuration relative to the other to check for small holes in one or more of the layers of the package 4. Alternatively, two such apparatus can be spatially collocated and operated in an alternating manner as the packages 4 are actuated past them, as shown in FIGS. 2 and 3.

Referring to FIG. 5, there is shown a graph of the signal 44 in more detail. The graph comprises a horizontal axis for representing instantaneous scanning angle θ of the beam 18, and a vertical axis for representing intensity of the signal 44. For most of the beam cycle, the signal trace intensity 46 is minimal, but when the beam 18 reaches the hole 36, the increased intensity peak 47 of light received by the detector 20 is clear. The position of the hole 36 can then be accurately determined by knowing the position (both across and along) of the beam on the blister package, when the peak 47 occurred. Hence, the advantage of use of a scanned beam over methods of detecting holes using diffuse or static lighting.

The processing unit 8 is programmed to detect for one or more peaks similar to the peak 47. The apparatus is capable of detecting holes in the packages 10 where the holes have diameters approaching a lower limit in the order of 10 μm diameter, possibly lower. The apparatus is capable of detecting the presence and position of small pinholes having a diameter in a range of 5 μm to 150 μm for example. Gross defects in the package 4 are also detectable by the apparatus.

The apparatus thereby is capable of continuously monitoring packages for defects such as holes at a relatively fast rate. Translation speeds of up to 50 cm/second for packages through the apparatus whilst potentially detecting holes in the packaging as small as 5 μm diameter can be achieved using the apparatus.

Although the use of optical radiation is described above, it will be appreciated that the invention is applicable using beams of microwave radiation, such as used for detecting holes in large hollow metallic structures, for example steel storage tanks employed in the petrochemicals industry.

The packages 4 are generally translating along a continuously-moving conveyor belt 2 in a direction non-coincident with the direction in which the beam 18 is scanned. More preferably, the packages 4 are moved in a direction substantially orthogonal to an axis substantially along which the beam 18 is scanned in operation.

It is mentioned that the use of a beam of radiation which is scanned across the relevant surface of the blister package ensures that the radiation has sufficient concentration when passing through holes or apertures as small as 5 micron, such that there is sufficient internal reflection within the pocket to cause propagation of the radiation through the plastics layer, which can then be picked up by sensitive photo-detectors. It is considered that non-scanned light would provide insufficient intensity at any one location so as to be able to provide sufficient internal reflection for transverse transmission. Naturally, the larger the hole size, the stronger the emitted radiation and thus level of detection. However, it is desired by blister package manufacturers to be able to detect imperfections at the lowest possible size level and at speed, rather than gross imperfections at speed, or weak imperfections through static testing only.

FIG. 6 shows a similar arrangement to FIG. 4, but wherein the blister package 48 is a thermoform blister package, having an aluminium foil top layer 52, and a plastics pocket or tray layer 54. Generally, the plastics layer 54 will be thicker than the plastic layer 32 of a coldform blister package, as it requires to impart greater structural strength to the pocket. In the pocket is a pharmaceutical tablet 56.

This package 48 can again pass along apparatus as hereinbefore described, and have a similar scanned beam 18 passing thereacross its flat side 52. Should a hole 60 be present in the flat side 52, light enters the pocket and is internally reflected 62. As the plastics layer 54 is translucent and/or transparent, light will then be emitted across the pocket and be visible by transmitted light beams 64, which can be picked up by a photo detector 58. Photo detector 58 may not have the sensitivity of other photo detectors such as that in FIGS. 2 and 4, as it is more broadly looking for general transmission of light across a pocket. Again, the blister package 48 preferably has light barriers 12 to assist in the prevention of radiation reaching the detector 58 other than that emitted by the pocket.

Of course, light transmitted and edge emitted 68 through and by the plastics layer of the blister package 48 can alternatively or also be detected in the arrangement in FIG. 6, e.g. by photo detector 66. The intensity of any radiation detected by photo detector 66 may be less than that shown in the arrangement in FIG. 4, but may nevertheless still be differentiated from background radiation when no hole is present in the flat side 52 of the blister package 48. Thus, the arrangement shown in FIG. 4 is still usable for determining for example any imperfections, especially holes, in the flat side 52 of blister package 48, especially the pocket lids of blister packages in the form of a thermoform package.

FIG. 7 shows a similar thermoform blister package 50 passing along direction M of the apparatus of FIG. 1, and having radiation from sources 70 imaging light 72 across its pocket side. Reflection of the beams 72 can be detected by detector 74. Any change in the expected reflection or intensity of reflection due to an imperfection such as a hole (not shown) in a pocket of the blister package 50 would be noted by the detector 74, and thus imperfections such as holes can also be determined in the pocket side of a thermoform blister package.

An embodiment of a blister package inspecting apparatus according to another embodiment of the present invention is shown in FIG. 8. The apparatus can inspect the same or a different blister package 4 (or 48 or 50) for regions of weak or broken sealing or capillary discontinuities in the seal comprises one or more light sources arranged to direct light onto the lidding foil 30 defining the flat side of the blister package 4 at an incident angle of greater than 45°, preferably between 60° and 80°.

Preferably two light sources 100 are provided, directing light at the lidding foil 30 of the blister package 4 in substantially opposite directions. Each light source 100 preferably comprises one or more LEDs in a suitable array, e.g. circular around the blister package, and some collimating optics, but could also comprise a laser as in the first embodiment, white light source or some other appropriate light source. In an integrated system the light source 100 may be the same component as the light source 14 for detecting leaks in the blister packages. The light sources 100 are configured so that the lidding foil 30 is illuminated by light that is incident on the lidding foil 30 at a glancing angle.

The illuminated lidding foil 30 is imaged using a camera 102 arranged substantially normally to the flat side of the blister package 4, and the images are then analysed by a processor 104. The camera 102 is preferably a high resolution (>2 megapixel) CCD camera, with a flat field lens.

Illuminating the lidding foil 30 with light that is incident at a low angle enables the camera 102 and processor 104 to view and analyse the surface texture of the blister package 4 by means of the pattern of reflected light viewed by the camera 102. This surface texture can be used to evaluate the integrity of the seal and whether capillaries are present.

As described above, after the sealing process, at least part, possibly all of, the lidding foil 30 has a textured surface. The depth of the texture is dependent on the integrity of the sealing process. Strongly bonded blister packages 4 have a far more pronounced texture than weakly bonded packages. The use of low angle illumination is designed to highlight this difference in surface texture. This is illustrated in FIGS. 9a and 9b.

FIG. 9a shows the direction of reflected light from the textured surface of the lidding foil 30 of a strongly sealed blister package 4. A strong seal 110 has a much more pronounced surface texture than a weak seal 130. When a strong seal 110 is illuminated by low angle illumination, a large proportion of the reflected light 120 is reflected in a direction at or near to perpendicular to the surface of the blister package 4.

FIG. 9b shows the direction of reflected light from the textured surface of the lidding foil 30 of a weakly sealed blister package, wherein the textured surface of the lidding foil has a less pronounced surface texture. When a weak seal 130 is illuminated using the same configuration, only a small proportion of the reflected light 140 is reflected at or near to perpendicular to the flat side of the blister package, the majority of the light being reflected in direction 140 having a greater angle of incidence.

By locating the camera 102 substantially perpendicular to the flat side of the blister package 4, it will detect different light signatures from good and weak seals. Should space considerations dictate otherwise, it is envisaged that the camera 102 may be orientated in a direction other than perpendicular to the lidding foil 30 of the blister package 4 without compromising the ability of the apparatus to detect faulty blister packages. However, it is preferred that the camera 102 be arranged at an angle of no more than 30° from the vertical.

The intensity and area of the light reflected off the intended textured surface provides a measure of the depth of the indentation. (The image of each indentation will be referred to as a ‘particle’ hereinafter).

To determine the quality of the seal, the quality of the individual particles is first determined. A good particle is defined as one of sufficient size after applying an intensity threshold to the image, i.e. a good particle is formed by a sufficient number of grouped pixels of the above specified intensity level.

In practice it is found that there is a wide range of acceptable indentation depths, thus range of reflected light intensity. If a single intensity threshold is applied, some regions with deep indentations may merge together and appear as one larger ‘island’ and the individual indentation quality cannot be determined.

To help avoid erroneous results, a range of intensity thresholds can be sequentially applied to the image. A first intensity threshold enables deep indentations to be qualified (without them appearing as single large islands) and the subsequent intensity thresholds identify indentations of lesser, but still acceptable, quality.

An additional criterion to limit the allowable maximum size of the particle is used to exclude island formations as the thresholds are lowered.

The process can be as follows:
1. The image is captured.
2. The intensity threshold is applied to the image.
3. The image is then processed and good particles are identified:
   a. above a minimum size threshold
   b. below a maximum size threshold

The second criterion excludes any island formations.
4. Steps 2 and 3 are repeated for a range of intensity thresholds.
5. The results from the subsequent tests are overlaid locating all ‘good’ indentations.

Computer software can then draw a non-filled, i.e. open circle (square or oval could be used) around each particle. The radius of the circle is chosen such that the circles around neighbouring particles will overlap each other. If all indentations are good, the image will be formed of approximately equidistant particles, each surrounded by a circle.

If an indentation is imperfect, one particle and one circle are missing. If several indentations are imperfect, it is possible that air can leak in through a line or “canal” consisting of imperfect indentations. This canal manifests itself in the processed image as a region without circles.

To test whether a pocket leaks to the outside, a point outside the pocket is specified. It is then tested whether it is possible to go from the point outside of the package to the inside of a pocket in question without having to cross the line of a circle. If this is possible, the pocket is defined as having a leak. The programme is a “flood” function.

Similarly, testing for leaks between pockets is done by testing whether the centre of the first pocket can be reached from the centre of the second pocket without needing to cross the line of a circle.

For capillaries, it can be the same type of procedure, i.e.: apply high threshold to the image; choose islands bigger than typical spots; broaden the islands; and then see if it is possible to connect the islands with a thin line. If so, there is a capillary imperfection.

FIG. 10 shows the illuminated image 150 of a blister package 4 having a strong seal, as viewed by the camera 102. By contrast, FIG. 12 shows the illuminated image 152 of a blister package having a weak seal, as viewed by the camera 102. Clearly more reflected light is received by the camera 102 when viewing the blister package having a good seal. Furthermore, a strongly sealed package will create an image with a high degree of variation in detected light intensity, and a weakly sealed package will create an image with less marked variation. The processing device 104 can automatically differentiate between images corresponding to good and weak seals, possibly by referencing the image to that of a good seal or to predetermined calibration data.

As shown in FIG. 11, in the case of a package that is strongly sealed for the majority of its surface area, a localised variation in texture 154 can be detected, indicating the presence of a weakly sealed area or region.

FIG. 13 shows the image produced by a well sealed package containing a capillary 156. If a capillary 156 is present it will disrupt the pattern that should be present on the lidding foil 30 surface. Under low angle light illumination, the disruption to the surface will be highlighted as a bright continuous line. This will be highlighted on camera images and detected by the processor 104.

In a preferred embodiment both the leakage detecting apparatus of the FIGS. 2-7 and the seal inspecting apparatus of FIG. 8 can be provided, for example, in a single blister package testing unit provided at the end of a blister package manufacturing line. This unit can provide real-time quality control for all blister packages produced on the line, avoiding the need for batch testing of blister packages at the end of the manufacturing process, thus greatly increasing the quality control to 100% of the production process.

The seal inspecting apparatus and the leakage testing apparatus may be arranged in series such that the blister packages first pass through one apparatus and then the next, or may be integrated to simultaneously inspect the sealing of the blister packages and detect leakages in the pockets. In one arrangement, a common radiation source could be utilised for both purposes, with appropriate photo-detectors and camera being arranged to respectively detect radiation guided to and emitted from the edge of the blister packages indicating the presence of pin-holes in the blister package and to determine the integrity of the seal and/or the presence of capillaries by assessing the pattern of light reflected from the lidding foil and/or pocket of the blister packages.

Unlike the present invention, known methods of inspecting the seal integrity of blister packages cannot operate at the output speeds of blister package production devices, which devices can operate at high speeds, which could be greater than 1000, such as up to 1200 or even 1400 packages per minute.

Both the leakage detecting apparatus of FIG. 2 etc and the seal inspecting apparatus of FIG. 8 etc could also be integrated into the blister package production process, and be provided with conveying devices or other handling means for intercepting blister packages that are determined as having sealing faults. Such rejected blister packages may subsequently be subject to traditional batch leak inspection processes if desired.

Whilst the preferred embodiment specifically relates to an apparatus and method for the inspection of a pharmaceutical blister package, the invention is equally applicable to any product packaged in blister packages of any shape or size.

It will be appreciated that modifications can be made to embodiments of the invention described in the foregoing without departing from the scope of the invention.

1. A method for detecting at atmospheric pressure an imperfection in a blister package having at least one radiation transmissible layer, and optionally moving, the blister package having a flat side and a pocket side, the method comprising the steps of:
(a) directing radiation from a source at the flat side and/or the pocket side of the blister package;
(b) detecting any radiation emitted from at least one edge of the blister package; and
(c) inhibiting the passage of radiation between the source of radiation and the blister package edge(s).

2. A method as claimed in claim 1, further comprising the step of determining the presence of a hole in a pocket or the lid of a pocket of the blister package based upon the detected intensity of radiation emitted from at least one edge of the blister package.

3. A method as claimed in claim 1, wherein the step of directing radiation is directed by movement, preferably scanning, of the flat side and/or the pocket side of the blister package.

4. An apparatus for detecting at atmospheric pressure an imperfection in a blister package having at least one radiation transmissible layer, and optionally moving, the blister package having a flat side and a pocket side, the apparatus comprising means for directing radiation at one or both sides of the blister package, means for detecting any radiation emitted from at least one edge of the blister package, and means to inhibit the passage of radiation between the means for directing radiation and the blister package edge(s).

5. An apparatus as claimed in claim 4, wherein the radiation at the blister package is a focused beam, and preferably comprises an optical light source, more preferably a laser.

6. An apparatus as claimed in claim 5, wherein the light is directed by deflection through a beam scanner or mirror for raster scanning a beam of light from the light source across the said side of the blister package in a direction transverse to the direction of movement of the blister package through the apparatus.

7. An apparatus as claimed in claim 4, wherein the means for detecting radiation emitted from the edges of the blister package comprises one or more photo-detectors, preferably located wholly or substantially in alignment with the edge or edges of the blister package.

8. An apparatus as claimed in claim 7 wherein a signal processing unit is provided for processing the radiation measurements recorded by the photo-detectors to determine the occurrence and/or position of changes in the measured radiation levels indicative of one or more imperfections, preferably holes or apertures, in the package.

9. An apparatus as claimed in claim 4, wherein conveying means are provided for conveying the blister packages through the apparatus.

10. A method for detecting an imperfection in the flat side of a blister package, optionally moving, the blister package having a flat side and one or more radiation-transmissible pockets on a pocket side, the method comprising the steps of directing radiation at the flat side of the blister package and detecting any radiation emitted from the or each pocket.

11. An apparatus for detecting an imperfection in the flat side of a blister package, optionally moving, the blister package having a flat side and one or more radiation transmissible pockets in a pocket side, the apparatus comprising means for directing radiation at the flat side of the blister package, and means for detecting any radiation emitted from the or each pocket of the blister package.

12. A method of detecting an imperfection in a blister package having at least one radiation transmissible layer, optionally moving, the blister package having a flat side and one or more pockets in a pocket side, the method comprising the steps of scanning a beam of radiation at the flat side and/or the pocket side of the blister package and detecting any radiation, preferably the intensity of any radiation, emitted from the pocket(s) and/or at least one edge of the blister package.

13. A method as claimed in claim 12 wherein the imperfection is in the form of a hole or aperture, and the radiation is in the form of light, preferably a laser.

14. An apparatus for detecting an imperfection in a blister package having at least one radiation transmissible layer, and optionally moving, the blister package having a flat side and one or more pockets in a pocket side, the apparatus comprising means for scanning a beam of radiation across one or both sides of the blister package, and means for detecting the presence, preferably the intensity, of any radiation emitted from the pocket(s) and/or at least one edge of the blister package.

15. A method of detecting an imperfection in the pocket side of a blister package, optionally moving, the blister package having a flat side and pocket side, the method comprising the steps of directing radiation at the pocket side of the blister package and detecting the angle and/or intensity of radiation reflected therefrom.

16. An apparatus for detecting an imperfection in the pocket side of a blister package, optionally moving, the blister package having a flat side and pocket side, the apparatus comprising means for directing radiation at the pocket side of the blister package, and means for detecting the angle and/or intensity of radiation reflected therefrom.

17. A method for inspecting the sealing of a blister package, optionally moving, the blister package having a flat side and a pocket side, at least a portion of one or both sides having a textured surface, the method comprising the steps of directing radiation at the textured surface of the blister package at an angle of incidence of greater than 0° and detecting the angle and/or intensity of radiation reflected therefrom.

18. A method as claimed in claim 17, wherein the steps of directing radiation onto the flat side of the blister package and detecting the angle and/or intensity of radiation reflected therefrom are carried out across at least a portion of the flat surface of the blister package.

19. An apparatus for inspecting the sealing of a blister package, optionally moving, the blister package having a flat side and a pocket side, at least a portion of the flat side having a textured surface, the apparatus comprising means for directing radiation at the textured surface of the blister package at an angle of incidence of greater than 0° and means for detecting the angle and/or intensity of radiation reflected therefrom.

20. An apparatus as claimed in claim 19, wherein the radiation comprises visible light.

21. An apparatus as claimed in claim 20, wherein the radiation comprises a beam of coherent light from a laser.

22. An apparatus as claimed in claim 19, wherein the angle of incidence of the radiation directed at the textured surface is greater than 45°, more preferably between 60° and 80°.

23. An apparatus as claimed in claim 19, wherein the detecting means is arranged to detect the intensity of radiation reflected in a direction substantially normal to the flat side of the blister package.

24. An apparatus as claimed in claim 19, wherein image processing means are provided for determining the pattern of reflected radiation across at least a portion of the surface of the flat side of the blister package.

25. An apparatus as claimed in claim 24, wherein said image processing means determines the position(s) and/or the presence of overall and/or localised regions of weak or faulty sealing.

26. An apparatus as claimed in claim 25, wherein the image processing means comprises a camera connected to a computing device.

27. An apparatus as claimed in claim 4, wherein the apparatus further comprises means for determining the acceptability of the sealing of the blister package based upon the detected angle and/or intensity of the reflected radiation.

28. A method as claimed in claim 1 wherein the method includes the further step of determining the acceptability of the blister package based upon the detected angle and/or intensity of the reflected radiation.

29. A method as claimed in claim 28, wherein the acceptability determination comprises determining whether the package being inspected meets or fails to meet a particular quality requirement and/or determining the quality of the blister package as falling into one of a range of levels of quality, some being rejected, some accepted and other being identified as requiring further checking.

30. (canceled)

31. (canceled)

32. An apparatus as claimed in claim 11, wherein the apparatus further comprises means for determining the acceptability of the sealing of the blister package based upon the detected angle and/or intensity of the reflected radiation.

33. An apparatus as claimed in claim 14, wherein the apparatus further comprises means for determining the acceptability of the sealing of the blister package based upon the detected angle and/or intensity of the reflected radiation.

34. An apparatus as claimed in claim 16, wherein the apparatus further comprises means for determining the acceptability of the sealing of the blister package based upon the detected angle and/or intensity of the reflected radiation.

35. An apparatus as claimed in claim 18, wherein the apparatus further comprises means for determining the acceptability of the sealing of the blister package based upon the detected angle and/or intensity of the reflected radiation.

36. An apparatus as claimed in claim 26, wherein the apparatus further comprises means for determining the acceptability of the sealing of the blister package based upon the detected angle and/or intensity of the reflected radiation.

37. A method as claimed in claim 10, wherein the method includes the further step of determining the acceptability of the blister package based upon the detected angle and/or intensity of the reflected radiation.

38. A method as claimed in claim 12 wherein the method includes the further step of determining the acceptability of the blister package based upon the detected angle and/or intensity of the reflected radiation.

39. A method as claimed in claim 15 wherein the method includes the further step of determining the acceptability of the blister package based upon the detected angle and/or intensity of the reflected radiation.

40. A method as claimed in claim 17 wherein the method includes the further step of determining the acceptability of the blister package based upon the detected angle and/or intensity of the reflected radiation.

41. A method as claimed in claim 1, further comprising the steps of directing radiation at the flat side of the blister package and detecting any radiation emitted from the or each pocket.

42. A method as claimed in claim 1, further comprising the steps of scanning a beam of radiation at the flat side and/or the pocket side of the blister package and detecting any radiation, preferably the intensity of any radiation, emitted from the pocket(s) and/or at least one edge of the blister package.

43. A method as claimed in claim 1, wherein the imperfection is in the form of a hole or aperture, and the radiation is in the form of light, preferably a laser.

44. A method as claimed in claim 1, further comprising the steps of directing radiation at the pocket side of the blister package and detecting the angle and/or intensity of radiation reflected therefrom.

45. A method as claimed in claim 1, further comprising the steps of directing radiation at the textured surface of the blister package at an angle of incidence of greater than 0° and detecting the angle and/or intensity of radiation reflected therefrom.

46. A method as claimed in claim 1, further comprising determining whether the package being inspected meets or fails to meet a particular quality requirement and/or determining the quality of the blister package as falling into one of a range of levels of quality, some being rejected, some accepted and other being identified as requiring further checking.

47. A method as claimed in claim 4, further comprising means for directing radiation at the flat side of the blister package, and means for detecting any radiation emitted from the or each pocket of the blister package.

48. A method as claimed in claim 4, further comprising means for scanning a beam of radiation across one or both sides of the blister package, and means for detecting the presence, preferably the intensity, of any radiation emitted from the pocket(s) and/or at least one edge of the blister package.

49. A method as claimed in claim 4, further comprising means for directing radiation at the pocket side of the blister package, and means for detecting the angle and/or intensity of radiation reflected therefrom.

50. A method as claimed in claim 4, wherein comprising the steps of directing radiation onto the flat side of the blister package and detecting the angle and/or intensity of radiation reflected therefrom carried out across at least a portion of the flat surface of the blister package.

51. A method as claimed in claim 4, further comprising means for directing radiation at a textured surface on at least a portion of the flat side of the blister package at an angle of incidence of greater than 0° and means for detecting the angle and/or intensity of radiation reflected therefrom.
